(19) United States
(12) Patent Application Publication
(10) Pub. No.: US 2010/0025239 A1
(43) Pub. Date: Feb. 4, 2010

(54) Biosensor

(75) Inventor: Ching-Hsin Cho, Wugu Hsiang (TW)

Correspondence Address: BACON & THOMAS, PLLC, 625 SLATERS LANE, FOURTH FLOOR, ALEXANDRIA, VA, 22314-1176, US

(73) Assignee: BIOMEDIX TAIWAN CO., LTD., Taipei Hsien (TW)

(21) Appl. No.: 12/230,263

(22) Filed: Aug. 27, 2008

(30) Foreign Application Priority Data
Aug. 1, 2008 (TW) 097213709

(51) Int. Cl. G01N 27/327

(52) U.S. Cl. 204/412; 204/400

(57) ABSTRACT

A biosensor is a sensor strip that is folded to form a base and a cover. The base has sides, a reactive layer and two electrodes. One of the electrodes is mounted longitudinally on the base, extends from the base to the cover and is covered with insulating materials. The other electrode is mounted on the base from an end of the base to the reactive layer. The cover bonds to and is shorter than the base and has a sample notch. The sample notch is formed in one side of the cover, corresponds to the reactive layer and is near the electrode on the reactive layer. A sample reacts thoroughly with the reactive layer because the anode on the cover takes time to transfer electrons therefore accurate test results are obtained.

### BACKGROUND OF THE INVENTION

1. Field of Invention

The present invention relates to a biosensor, and more particularly to a biosensor that allows blood to react thoroughly with a reactive layer, so test results are accurate.

2. Description of the Related Art

Generally, a patient who needs to do periodic blood tests (such as blood sugar measurement, triglyceride measurement, cholesterol measurement, high-density lipoprotein measurement, low-density lipoprotein measurement, etc.) uses a biosensor that incorporates a biosensor detector allowing the patient to determine his or her physical condition virtually anywhere.

US publication No. 20030202906 disclosed a biosensor comprising a sensor strip. The sensor strip is folded to form a base and a cover. The base has an upper surface, two sides, an end, a distal end, a reactive layer and two electrodes. The reactive layer is mounted on the upper surface of the base. The electrodes are mounted on the upper surface of the base respectively near the sides of the base and each electrode is formed from the reactive layer to the sensing end of the base. The cover is shorter than the base, is bonded to the upper surface of the base, is flush with the distal end, covers the reactive layer of the base and leaves the sensing end of the base exposed. The cover has a lower surface and a through hole. The through hole is defined through the cover in a center of the corresponding reactive layer and between the electrodes.

When the biosensor is used, a drop of blood or other liquid sample is dropped through the through hole onto the reactive layer. Blood reacts with the reactive layer to generate electrons. The electrons will move between the electrodes and become a circuit with an electric current. Then, the sensing end of the base is inserted into a biosensor detector to detect the electric current and display a test result.

However, the conventional biosensor has a significant shortcoming. The through hole being formed in the center of the reactive layer and between the electrodes allows blood dropped on the reactive layer to react with the reactive layer to contact the electrodes and allow electrons to move immediately between the electrodes before the blood reacts thoroughly with the reactive layer. Therefore, the electric current is unstable, and the test results are not accurate, which can lead to undetected traumatic physical conditions and may lead to death.

US publication No. 20050252769 disclosed another conventional biosensor. The structure of the conventional biosensor is similar to that of the conventional biosensor described above, but the through hole of the cover is formed in one side of the cover and near one of the electrodes. Therefore, a drop of blood or other liquid sample is dropped in the through hole and then moves from the side that the through hole is located toward another side to contact another electrode.

However, the distance between two electrodes is too short to allow a sufficient period of time for reaction making the reactive layer react with the liquid sample thoroughly.

To overcome the shortcomings, the present invention provides a biosensor to mitigate or obviate the aforementioned.

### SUMMARY OF THE INVENTION

The primary objective of the present invention is to provide a biosensor that allows blood to react thoroughly with a reactive layer, so test results are accurate.

To achieve the objective, a biosensor in accordance with the present invention is a sensor strip that is folded to form a base and a cover. The base has sides, a reactive layer and two electrodes. One of the electrodes is mounted longitudinally on the base, extends from the base to the cover and is covered with insulating materials. The other electrode is mounted on the base from an end of the base to the reactive layer. The cover bonds to and is shorter than the base and has a sample notch. The sample notch is formed in one side of the cover, corresponds to the reactive layer and is near the electrode on the reactive layer. A sample reacts thoroughly with the reactive layer because the anode on the cover takes time to transfer electrons therefore accurate test results are obtained.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a first embodiment of an unfolded biosensor in accordance with the present invention;

FIG. 2 is a perspective view of the folded biosensor in FIG. 1;

FIG. 3 is a top view of the biosensor in FIG. 2;

FIG. 4 is a cross sectional end view of the biosensor in FIG. 3 along line 4-4; and

FIG. 5 is a perspective view of a second embodiment of an unfolded biosensor in accordance with the present invention.

### DETAILED DESCRIPTION OF THE INVENTION

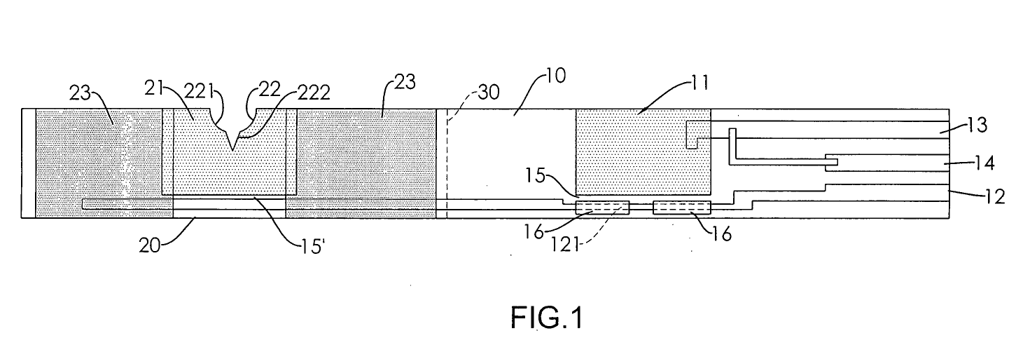

With reference to FIG. 1, a biosensor in accordance with the present invention is a sensor strip. The sensor strip is folded along a folding line (30) and comprises a base (10) and a cover (20). The cover (20) extends from the base (10) and may be folded on the base (10).

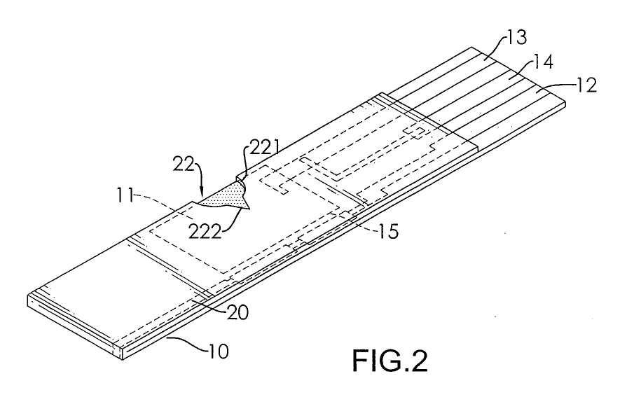

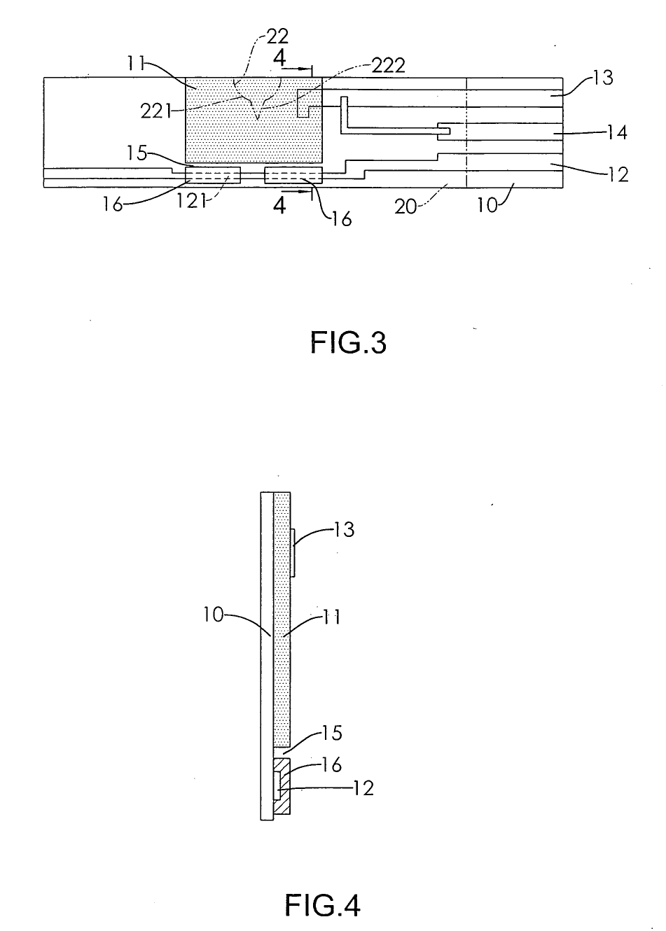

With further reference to FIGS. 2 and 3, the base (10) has an upper surface, two sides, a sensing end, a reactive layer (11), a margin (15), two electrodes (12, 13) and an identifying electrode (14). The sensing end of the base (10) selectively plugs into a biosensor detector.

The reactive layer (11) is mounted on the upper surface of the base (10) adjacent to one side of the base (10). For the biosensor to detect blood sugar, the reactive layer (11) may comprise a composition including: (A) an enzyme (such as glucose oxidase, etc.); (B) enzyme protectors (such as albumin, dextrin, dextran, amino acid, etc.); (C) a conductive medium (such as potassium, etc.); (D) surfactant (such as triton X-100, triton X-405, triton X-114, sodium lauryl sulfate, tween 20 (polyoxyethylenesorbitan monolaurate), tween 40 (polyoxyethylenesorbitan monopalmitate), tween 60 (polyoxyethylenesorbitan monostearate), tween 80 (polyoxyethylenesorbitan monooleate), another water-soluble surfactant, a cleaning agent, etc.); (E) a buffer that is salt (such as phosphate, etc.); and (F) water (such as distilled water).

The margin (15) is a space, is formed on the upper surface of the base (10) between the other side of the base (10) and the reactive layer (11).

The electrodes (12, 13) are mounted on the upper surface of the base (10) and extend to the sensing end of the base (10). The electrodes (12, 13) are an anode (12) and a cathode (13).

The anode (12) is a strip, is formed longitudinally on the base (10), extends from the sensing end of the base (10) toward the cover (20) via the folding line (30) and has a proximal end and a distal end and an intermediate section (121). The proximal end of the anode (12) is at the sensing end of the base (10). The distal end is at the cover (20). The anode (12) formed through the margin (15) so that the intermediate section (121) is located in the margin (15). The intermediate section (121) in the margin (15) is covered with insulating materials. The anode (12) on the cover (20) overlaps on the insulating materials when the sensor strip is folded to partially insulate the intermediate section (121) in the margin (15) and the reactive layer (11).

With further reference to FIG. 4, the intermediate section (121) of the anode (12) in the margin (15) in the first embodiment of the biosensor is covered with two insulating layers (16). The insulating layers (16) cover the intermediate section (121) of the anode (12) in the margin (15) at an interval to insulate partially the anode (12) from the margin (15) and the reactive layer (11).

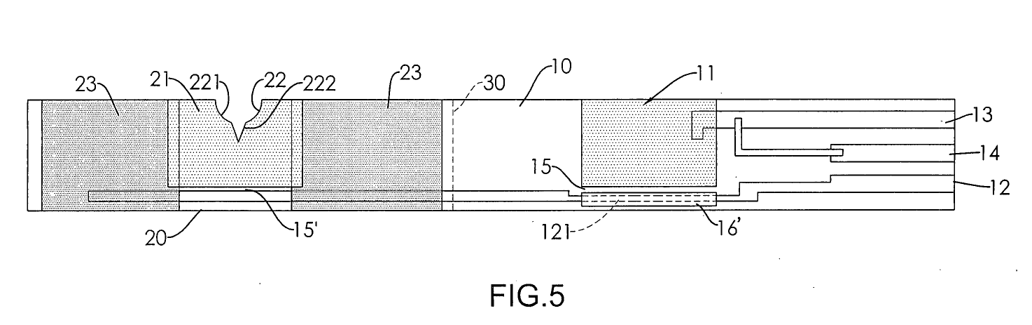

With further reference to FIG. 5, the intermediate section (121) of the anode (12) in the margin (15) in the second embodiment of the biosensor is a preferred embodiment. The intermediate section (121) of the anode (12) in the margin (15) is covered overall with an insulating layer (16′). The insulating layer (16′) entirely covers the intermediate section (121) in the margin (15) to insulate thoroughly the anode (12) from the reactive layer (11).

The cathode (13) is a strip, is shorter than the anode (12), is formed longitudinally on the base (10) and has a proximal end and a distal end. The proximal end of the cathode (13) is at the sensing end of the base (10). The distal end is mounted on the reactive layer (11).

The identifying electrode (14) is formed between the anode (12) and the cathode (13) without contacting the reactive layer (11) and allows a biosensor detector to recognize which test the biosensor performs (including, but not limited, to blood sugar measurement, triglyceride measurement, cholesterol measurement, high-density lipoprotein measurement, low-density lipoprotein measurement). The identifying electrode (14) has a proximal end and a distal end. The proximal end of the identifying electrode (14) is at the sensing end of the base (10). The distal end is mounted near the reactive layer (11).

The cover (20) is shorter than the base (10), is bonded to the upper surface of the base (10), covers the reactive layer (11) of the base (10) and exposes the sensing end of the base (10) and the proximal ends of the anode (12), the cathode (13) and the identifying electrode (14), which are inserted into a biosensor detector for detecting the electrodes (12, 13) and the identifying electrode (14). The cover (20) has two sides, a lower surface and a sample notch (22). The lower surface has a silver electrode membrane (21), a gap (15′) and adhesive layers (23). The silver electrode membrane (21) corresponds to the reactive layer (11) of the base (10) and has two ends. The gap (15′) is formed between the silver electrode membrane (21) and the anode (12) on the cover (20). The adhesive layers (23) are mounted on the lower surface of the cover (20), respectively overlap the ends of the silver electrode membrane (21), overlap partially on the intermediate section (121) of the anode (12) on the cover (20) and bond to the upper surface of the base (10). The sample notch (22) is formed in one side of the cover (20), corresponds to the reactive layer (11) of the base (10), is near the cathode (13) and allows blood or another liquid sample to be dropped on the reactive layer (11). The sample notch (22) comprises a semicircular notch (221) and a triangular notch (222). The semicircular notch (221) has a chord and an arc. The chord is flush with one side of the cover (20). The triangular notch (222) is formed from a center of the arc of the semicircular notch (221) toward the other side of the cover (20).

After the blood or another liquid sample is dropped on the reactive layer (11) through the sample notch (22), the blood or other liquid sample flows on and reacts with the reactive layer (11) from the semicircular notch (221) toward of the margin (15), which is guided by the triangular notch (222) to generate electrons.

At the first embodiment of the present invention, the blood or other liquid sample contacts the anode (12) in the margin (15) from the interval between two insulating layers (16), so the electrons allow the anode (12) and the cathode (13) to generate an electric current that is detected by the biosensor detector. It is noted that because the base (10) and the cover (20) are folded, part of the electron transfers through the silver electrode membrane (21) via the gap (15′) to contact the anode (12) on the cover (20). The electrons also transmit from the anode (12) on the cover (20) to the biosensor detector.

At the second embodiment of the present invention, the blood or other liquid sample cannot contact the intermediate section (121) of the anode (12) in the margin (15) because the insulating layer (16′) covers the intermediate section (121) in the margin (15) thoroughly. Accordingly the electrons transfers through the silver electrode membrane (21) via the gap (15′) and only contact the anode (12) on the cover (20) and an electric current from the anode (12) on the cover (20) transmits to the biosensor detector.

Therefore, the blood or other liquid sample reacts thoroughly with the reactive layer (11) because the anode (12) on the cover (20) takes time to transfer the electrons to the biosensor detector to obtain accurate test results.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A biosensor being a sensor strip that is folded along a folding line and the biosensor comprising:
a base having
an upper surface;
two sides;
a sensing end;
a reactive layer being mounted on the upper surface of the base adjacent to one side of the base;
a margin being a space, being formed on the upper surface of the base between the other side of the base and the reactive layer;
two electrodes being mounted on the upper surface of the base respectively near the sides of the base and extending to the sensing end of the base, wherein
one of the electrodes extending from the sensing end of the base toward the cover via the folding line and being formed through the margin that is covered with insulating materials allowing the anode on the cover to overlap on the insulating materials; and
the other one of the electrodes extending from the sensing end of the base toward the reactive layer; and
a cover being shorter than the base, being bonded to the upper surface of the base, covering the reactive layer of the base, exposing the sensing end of the base and the electrodes and having
two sides;
a sample notch being formed in one side of the cover, corresponding to the reactive layer of the base and being near one of the electrodes.

2. The biosensor as claimed in claim 1, wherein the electrode in the margin is covered with two insulating layers that cover the electrode in the margin at an interval.

3. The biosensor as claimed in claim 1, wherein the electrode in the margin being covered overall with an insulating layer that entirely covers the anode in the margin to insulate thoroughly the electrode in the margin from the reactive layer.

4. The biosensor as claimed in claim 1, wherein
the electrode extending from the sensing end of the base toward the cover via the folding line is anode;
the electrode extending from the sensing end of the base toward the reactive layer is cathode; and
the base further comprises an identifying electrode formed between the anode and the cathode.

5. The biosensor as claimed in claim 2, wherein
the electrode extending from the sensing end of the base toward the cover via the folding line is anode;
the electrode extending from the sensing end of the base toward the reactive layer is cathode; and
the base further comprises an identifying electrode formed between the anode and the cathode.

6. The biosensor as claimed in claim 3, wherein
the electrode extending from the sensing end of the base toward the cover via the folding line is anode;
the electrode extending from the sensing end of the base toward the reactive layer is cathode; and
the base further comprises an identifying electrode formed between the anode and the cathode.

7. The biosensor as claimed in claim 1, wherein the cover further comprises a lower surface that has
a silver electrode membrane corresponding to the reactive layer of the base; and
a gap formed between the silver electrode membrane and the electrode on the cover.

8. The biosensor as claimed in claim 4, wherein the cover further comprises a lower surface that has
a silver electrode membrane corresponding to the reactive layer of the base; and
a gap formed between the silver electrode membrane and the anode on the cover.

9. The biosensor as claimed in claim 5, wherein the cover further comprises a lower surface that has
a silver electrode membrane corresponding to the reactive layer of the base; and
a gap formed between the silver electrode membrane and the anode on the cover.

10. The biosensor as claimed in claim 6, wherein the cover further comprises a lower surface that has
a silver electrode membrane corresponding to the reactive layer of the base; and
a gap formed between the silver electrode membrane and the anode on the cover.

11. The biosensor as claimed in claim 7, wherein the lower surface of the cover further has two adhesive layers being mounted on the lower surface of the cover, respectively overlapping two ends of the silver electrode membrane, overlapping partially on the anode on the cover and bond to the upper surface of the base.

12. The biosensor as claimed in claim 8, wherein the lower surface of the cover further has two adhesive layers being mounted on the lower surface of the cover, respectively overlapping two ends of the silver electrode membrane, overlapping partially on the anode on the cover and bond to the upper surface of the base.

13. The biosensor as claimed in claim 9, wherein the lower surface of the cover further has two adhesive layers being mounted on the lower surface of the cover, respectively overlapping two ends of the silver electrode membrane, overlapping partially on the anode on the cover and bond to the upper surface of the base.

14. The biosensor as claimed in claim 10, wherein the lower surface of the cover further has two adhesive layers being mounted on the lower surface of the cover, respectively overlapping two ends of the silver electrode membrane, overlapping partially on the anode on the cover and bond to the upper surface of the base.

15. A biosensor that is folded and comprising:
a base;
a cover;
wherein the base comprises a reactive layer connecting with a first electrode, and the cover comprises a sample notch corresponding to the reactive layer of the base;
the base further has
a second electrode extending from the base to the cover such that the second electrode is opposite to the sample notch; and
an interval being located between the reactive layer and the second electrode; and
the second electrode next to the interval is covered with at least one insulating layer.

16. The biosensor as claimed in claim 15, wherein the cover further comprises
a silver electrode membrane corresponding to the reactive layer of the base and being adjacent to the second electrode; and
a gap formed between the silver electrode membrane and the anode on the cover.

17. The biosensor as claimed in claim 15, wherein the base further comprises an identifying electrode formed between two electrodes.
